(19) United States
(12) Patent Application Publication
(10) Pub. No.: US 2005/0111460 A1
(43) Pub. Date: May 26, 2005

(54) State-transition based network intrusion detection

(76) Inventor: Ravi L. Sahita, Beaverton, OR (US)

Correspondence Address: Blakely, Sokoloff, Taylor & Zafman LLP, Suite 101, 5285 S.W. Meadows Road, Lake Oswego, OR, 97035, US

(21) Appl. No.: 10/718,843

(22) Filed: Nov. 21, 2003

(51) Int. Cl. H04L 12/28

(52) U.S. Cl. 370/395.3

(57) ABSTRACT

A network intrusion detection unit (NIDU) identifies a protocol used to transmit a packet and the flow to which the packet belongs. The NIDU determines whether a rules table exists for the protocol, and determines, if the rules table exists, whether a state table includes a matching flow entry corresponding to the flow. If the state table includes the matching flow entry, the NIDU determines whether a state of the flow will transition from a current state indicated in the matching flow entry to a valid destination state indicated in a state-transition rule in the rules table. If the state of the flow will not transition to a valid destination state, the NIDU discards the packet.

### TECHNICAL FIELD

Embodiments of the invention are generally related to the field of networking and, in particular, to network intrusion detection.

### BACKGROUND

In general, a network is a group of two or more electronic systems linked by a wired or wireless transmission medium to transmit data, commonly referred to as a data packet or a packet, from a source electronic system to a destination electronic system. Data packets are transmitted based on a set of rules, commonly referred to as a protocol, that are used by the source and the destination during a communication session. Examples of networks include a personal area network, a local area network, a metropolitan area network and a wide area network, such as the Internet. Examples of electronic systems include a personal computer, a personal digital assistant (PDA), a laptop or palmtop computer, a cellular phone, a computer system, a network access device, and a television set-top box.

A data packet may travel through one or more intermediate electronic systems, commonly referred to as network devices, during transmission from a source to a destination. Examples of network devices include, but are not limited to, a switch, a router or a bridge. In general, a network device is a packet-forwarding device that receives a data packet and determines an electronic system (either another network device or a destination) to which to forward the data packet.

An unauthorized user may attempt to access a network. Unauthorized access of a network is commonly referred to as network intrusion. A network intruder may attempt to inhibit the ability of authorized users to access the network, or attempt to prevent the use of a service on the network, for example, electronic mail (or e-mail). Such an attack on a network is commonly referred to as a denial-of-service (DoS) attack.

One technique for implementing a DoS attack is to send a large amount of data to a service that is unable to handle the data and thus begins dropping data. For example, a network intruder may transmit a large number of requests to connect to an e-mail server that is unable keep up with the connection requests. As a result, the e-mail server may start dropping connection requests, including legitimate requests, thereby inhibiting authorized users' access to e-mail service.

A network intrusion detection system (NIDS) is a system used to determine whether a network is under attack. Typically, a NIDS examines packets entering a network to determine whether an unauthorized user is attempting to access the network. For example, a NIDS may determine whether there are a large number of connection request packets, which may indicate an attempted DoS attack. A NIDS may run either at a destination, where the destination's incoming traffic is examined, or on a network device between a source and a destination, in which case all network traffic is examined.

One type of NIDS is a signature-based NIDS, where the NIDS determines whether a packet includes a particular string of data that associates the packet with a network attack. Because the signature-based approach is based on data in the packet, only known attacks, i.e., attacks where a particular string of data is known to be associated with particular network attack, may be addressed. In addition, a signature-based NIDS examines an intrusive packet's data after the packet reaches an application that provides a service, which means that the attack is successful. Consequently, the goal of a signature-based approach is to prevent future attacks from being successful.

Another type of NIDS is an anomaly-based NIDS, in which network behavior is predicted and modeled, and certain behavior is identified as abnormal. An anomaly-based approach may be based on known protocol behavior, rather than on packet data known to be associated with a network attack. Consequently, an anomaly-based NIDS can address unknown, as well as known, attacks. In addition, an anomaly-based NIDS can prevent an attack before an intrusive packet reaches an application that provides a service. An anomaly-based NIDS is difficult to implement because of the difficulty in predicting and modeling network behavior and identifying abnormal behavior.

A conventional NIDS is susceptible to an attack in which packets are transmitted at high rates of speed, sometimes referred to as a saturation attack. A conventional NIDS examines the packets of each flow. In general, a flow is a stream of packets transmitted between a source and a destination during a communication session. If packets are transmitted faster than the NIDS is able to examine them, the NIDS may start dropping packets or even completely shut down. A conventional NIDS is not able to throttle flow examination, i.e., examine the packets of fewer than all flows, which would reduce the likelihood of a successful saturation attack.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram illustrating an example of a network.

FIG. 2 is a block diagram illustrating an example embodiment of a network intrusion detection unit.

FIG. 3 illustrates an example of a finite state machine.

FIG. 4 illustrates an example embodiment of a state transition rule.

FIG. 5 and FIG. 6 are a flow chart illustrating an example embodiment of a method of network intrusion detection.

FIG. 7 illustrates an example embodiment of determining a valid state transition.

FIG. 8 is a block diagram illustrating an example embodiment of an electronic system.

### DETAILED DESCRIPTION

State-transition based network intrusion detection is described. In the following description, for purposes of explanation, numerous specific details are set forth. It will be apparent, however, to one skilled in the art that embodiments of the invention can be practiced without these specific details. In other instances, structures and devices are shown in block diagram form in order to avoid obscuring the understanding of this description.

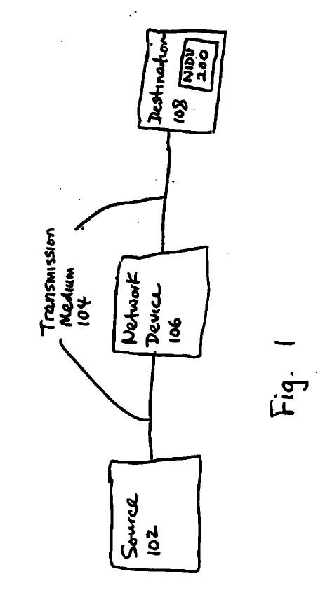

FIG. 1 is a block diagram illustrating an example of a network. Network 100 may be any type of wired or wireless network, including, but not limited to, a personal area network, a local area network, a metropolitan area network, or a wide area network. Network 100 includes source 102, which transmits data packets over transmission medium 104 through network device 106 to destination 108. For simplicity, network 100 is shown with one source, one network device and one destination. However, network 100 may include more than one source, network device and/or destination.

Source 102 is intended to represent a broad range of electronic systems including, but not limited to, a personal computer, a personal digital assistant (PDA), a laptop or palmtop computer, a computer system, a network access device or a television set-top box, that transmits data packets to destination 108. Transmission medium 104 is intended to represent any wired or wireless transmission medium, or a combination thereof, including, but not limited to, fiber-optic cable, coaxial cable, twisted-pair wire, or air, which carries, for example, radio or satellite signals, over which data packets are transmitted from source 102 to destination 108.

Network device 106 is intended to represent any number of network devices including, but not limited to, a router, a switch or a bridge, that include network intrusion detection unit (NIDU) 200. As explained in more detail below, the integration of NIDU 200 in network device 106 enables network device 106 to determine, based on the expected state transition of a flow, whether to transmit a data packet belonging to the flow to destination 108. Although network 100 is described in terms of a data packet traveling through network device 106, a data packet may be transmitted directly from source 102 to destination 108 without traveling though network device 106.

Destination 108 is intended to represent a broad range of electronic systems, including, but not limited to, a server, a personal computer, a personal digital assistant (PDA), a laptop or palmtop computer, a computer system, a network access device or a television set-top box, that include NIDU 200. As explained in more detail below, the integration of NIDU 200 in destination 108 enables destination 108 to determine, based on the expected state transition of a flow, whether to process a data packet belonging to the flow.

Network device 106 and/or destination 108 further includes a receive buffer (not shown) and a transmit buffer (not shown). NIDU 200 receives a packet via the receive buffer, and sends the packet to the transmit buffer if the packet is to be transmitted to destination 108 or processed at destination 108, as applicable, rather than discarded. Consequently, if NIDU 200 is running on a separate device, for example, a network processor or a network interface card, within network device 106 and/or destination 108, NIDU 200 is able to examine a packet before an intrusive packet reaches an application that is providing a service on destination 108.

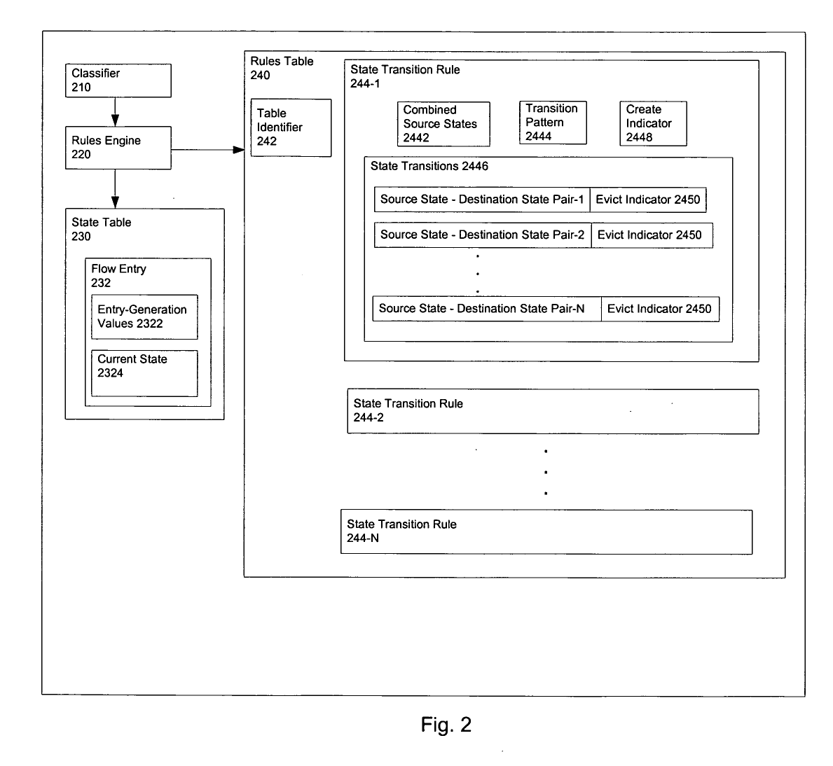

FIG. 2 is a block diagram illustrating an example embodiment of a network intrusion detection unit. NIDU 200 may be implemented in software, hardware, for example, on a network interface card or network processor, or a combination thereof. Although embodiments of the invention are described in terms of network intrusion detection, embodiments of the invention are also applicable to an application-aware firewall.

NIDU 200 includes classifier 210, rules engine 220, one or more state tables 230 and one or more rules tables 240. Although classifier 210 and rules engine 220 are described below as separate functional elements, they may be combined into a single multifunctional element that performs the functions of classifier 210 and rules engine 220. In addition, one or more of the functions described as being performed by classifier 210 may be performed by rules engine 220, and one or more of the functions described as being performed by rules engine 220 may be performed by classifier 210.

As explained in more detail below, classifier 210 identifies a protocol used to transmit a packet, and a flow to which the packet belongs. Many flows may exist for a single protocol, since any number of sources and destinations may be using a particular protocol to transmit packets during a communication session. Identifying the protocol and the flow is commonly referred to as classification.

State table (ST) 230 and rules table (RT) 240 are tables or other data structures related to a protocol used to transmit a packet. A user configures NIDU 200 to examine the flows of one or more protocols. ST 230 and RT 240 exist for each protocol NIDU 200 is configured to examine. ST 230 includes one or more flow entries 232, which identify each flow being transmitted using the protocol. Each flow entry 232 is an index representing a flow, and includes entry-generation values 2322, which indicate the values used to generate flow entry 232. For example, if the protocol is the Transmission Control Protocol (TCP), entry-generation values 2322 may include source address, destination address, source port number, and destination port. See, e.g., Request for Comments (RFC) 793, “Transmission Control Protocol DARPA [Defense Advanced Research Projects Agency] Internet Program, Protocol Specification,” September 1981. In addition, each flow entry 232 indicates a current state 2324 of the flow. Current state 2324 is represented by a bit-vector. For purposes of illustration and ease of explanation, ST 230 includes one flow entry. However, ST 230 may include any number of flow entries.

Rules table (RT) 240 includes table identifier 242 and one or more state-transition rules 244-1 through 244-N, where N is any number. Table identifier 242 may be any indicator known in the art for identifying a table or other data structure. Each state-transition rule 244 includes combined source states 2442, transition pattern 2444, state transitions 2446 and create indicator 2448. For purposes of illustration and ease of explanation, RT 240 includes one state transition rule, which is referred to herein generally as state-transition rule 244-N. However, RT 240 may include any number of state transition rules.

Typically, the operation of a protocol can be described based on a theoretical model commonly referred to as a finite state machine (FSM). A FSM is commonly represented as a set of unique states for a system, and a set of transitions between the states. Combined source states 2442 and state transitions 2446 correspond to states in a protocol's FSM, and are represented by bit-vectors.

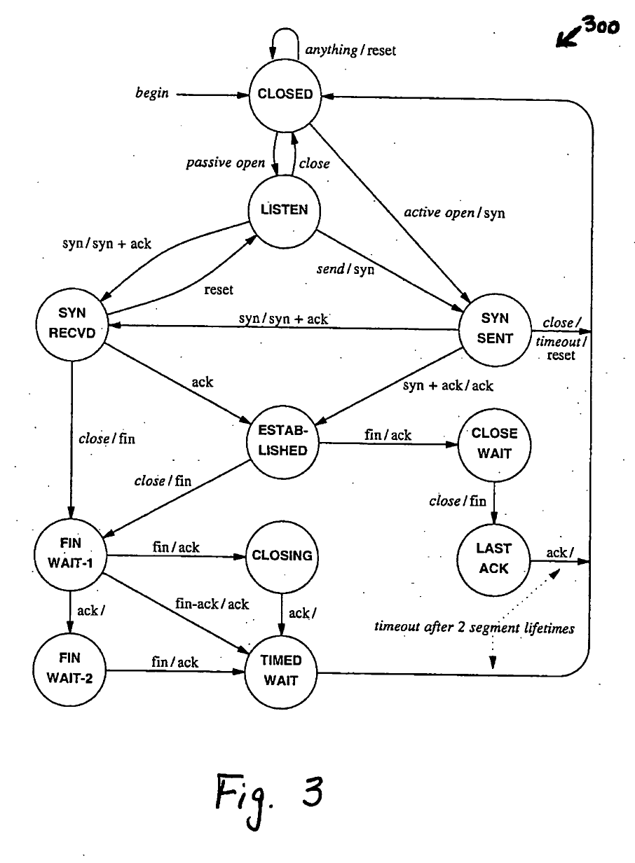

FIG. 3 illustrates an example of a finite state machine. Example FSM 300 is a FSM known in the art for TCP. In general, a flow begins at state 0 and transitions from state to state, based on data transmitted between source 102 and destination 108. For example, in order to transition from state 0 to state 1, source 102 sends a SYN packet to destination 108. The various symbols and notations in FSM 300 are known to those of ordinary skill in the art, and thus will not be described in detail.

For purposes of illustration and ease of explanation, embodiments of the invention will be described in terms of TCP. However, the protocol may be any protocol whose operation is capable of being defined by a FSM. Examples of other protocols include, but are not limited to, File Transfer Protocol (FTP), Telnet, Hypertext Transfer Protocol (HTTP), H.323, Real Time Transport Protocol (RTP)/Real Time Control Protocol (RTCP) and Secure Shell Protocol (SSH). See e.g., IETF RFC 959, “File Transfer Protocol (FTP),” October 1985; IETF RFC 854, “Telnet Protocol Specification,” May 1983; IETF RFC 2616, “Hypertext Transfer Protocol—HTTP/1.1,” June 1999; IETF RFC 3550 “A Transport Protocol for Real-Time Applications,” July 2003; International Telecommunication Union-Telecommunication Standardization Sector (ITU-T), “H.323 System Implementers Guide; Series H: Audiovisual and Multimedia Systems, Infrastructure of Audiovisual Services—Communication Procedures,” May 30, 2003; and IETF Network Working Group, SSH Communications Security Corp, “SSH Protocol Architecture,” Jul. 14, 2003 (Internet-Draft, Expires: Jan. 12, 2004.

State transitions 2446 include source state-destination state (SS-DD) pair 1 through SS-DD pair N, where N is any number. An SS-DD pair indicates a source state of a flow and a valid destination state to which the state of the flow will transition. State transitions 2446 may include any number of SS-DD pairs. For purposes of illustration and ease of explanation, one or more SS-DD pairs are referred to herein generally as SS-DD Pair N. Transition pattern 2444 indicates a pattern that is included in a packet if the state of the packet's flow is going to transition from a source state to a destination state included in an SS-DD Pair N. Combined source states 2442 indicates all of the source states in each SS-DD pair.

One or more state transitions 2446 further include evict indicator 2450. Evict indicator 2450 is used to indicate that a SS-DD pair corresponds to a final transition, and will cause a flow entry associated with the state-transition rule 244-N for the SS-DD pair to be removed from ST 230 or marked as invalid. Evict indicator 2450 may be, but is not limited to, a bit that when set indicates that a flow entry is to be evicted. For purposes of illustration and ease of explanation, evict indicator 2450 will be described in terms of an evict bit.

Create indicator 2448 indicates that a flow entry is to be created for a flow. Create indicator 2448 may be, but is not limited to, a bit that when set indicates that a flow entry is to be created in ST 230. This applies when a flow is to be examined, but NIDU 200 has not yet received a packet belonging to the flow. As explained in more detail below, if a packet belonging to the flow includes the correct transition pattern 2444, a flow entry corresponding to the flow will be created in ST 230. Once the flow entry has been created, the create bit is set so that rules engine 220 does not create another flow entry corresponding to the flow. For purposes of illustration and ease of explanation, create indicator 2448 will be described in terms of a create bit.

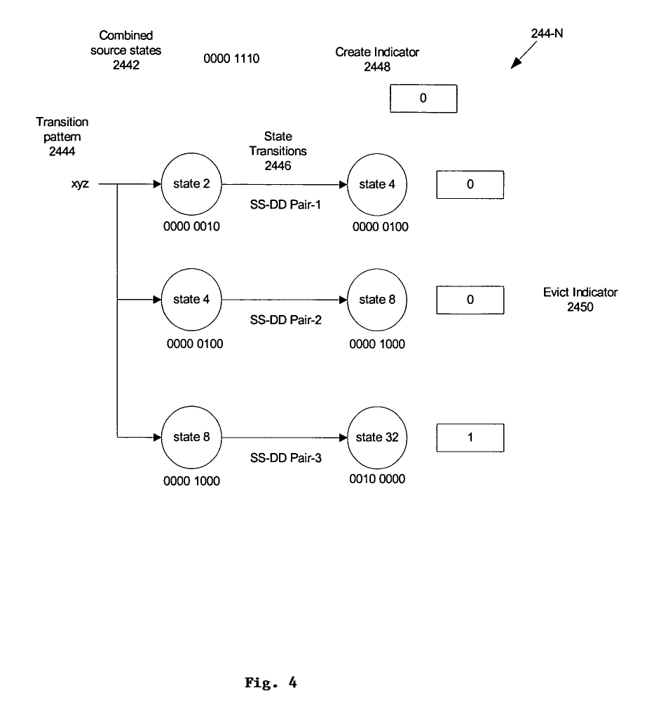

FIG. 4 illustrates an example embodiment of a state transition rule. State-transition rule 244-N indicates the source states of a flow as states 2, 4 or 8. Thus, state-transition rule 244-N indicates combined source states 2442 as bit-vector 00001110, which shows, by the 1 in the bit positions corresponding to binary numbers 2, 4 and 8, that states 2, 4 and 8 are source states.

State transition rule 244-N further includes state transitions 2446, which includes three SS-DD Pairs: SS-DD Pair 1 indicates state 2 as a source state and state 4 as its destination state; SS-DD Pair 2 indicates state 4 as a source state and state 8 as its destination state, and SS-DD Pair 3 indicates state 8 as a source state and state 32 as its destination state. Although state bit-vectors in FIG. 4 are described in terms of binary format, other formats may be used, for example, hexadecimal format.

Each SS-DD Pair includes evict indicator 2450, which in this case is an evict bit. Evict indicator 2450 for SS-DD Pairs 1 and 2 are set to 0 to indicate non-eviction, while evict indicator 2450 for Pair 3 is set to 1 to indicate eviction. Although FIG. 4 is described in terms of 0 for non-eviction and 1 for eviction, embodiments of the invention may be implemented using 1 to indicate non-eviction and 0 to indicate eviction.

For state-transition rule 244, transition pattern 2444 is XYZ. This means that if a packet belonging to a flow whose source state is 2, 4 or 8 includes the pattern XYZ, then the flow's next state is 4, 8 or 32, respectively. In addition, create indicator 2448 is set to 0. This indicates that a packet belonging to the flow corresponding to state-transition rule 244-N has been examined at NIDU 200, and thus a flow entry for the flow exists in ST 230.

As described in more detail below, rules engine 220 performs a hashing function based on data in a packet, and determines whether flow entry 232 in ST 230 matches the result of the hashing function. A matching flow entry 232 identifies a flow to which the packet belongs. If a matching flow entry 232 exists, rules engine 220 identifies current state 2324 of the flow.

Rules engine 220 uses current state 2324 to identify one or more state-transition rules 244-N having combined sources states 2442 that includes a source state corresponding to current state 2324. Rules engine 220 determines whether the packet includes transition pattern 2444 included in the state-transition rule 244. If the packet includes the transition pattern 2444, the packet is a valid packet, i.e., is not associated with an attempted network intrusion. However, if the packet does not include the transition pattern 2444, the packet is deemed to be associated with an attempted network intrusion.

Therefore, unlike a conventional network intrusion detection system, NIDU 200 is able to predict and model network behavior, and identify abnormal behavior. NIDU 200 does not detect network intrusion based solely on data in a packet, but rather also based on known protocol behavior. Consequently, NIDU 200 is able to prevent unknown and known network attacks, and can prevent network intrusions before an invasive packet reaches an application that provides a service.

A state-transition rule 244-N that has create bit 2448 set may also have additional values associated with it, specifically, a threshold value T and a step value S. T indicates a threshold number of flows being transmitted using the same protocol, while S indicates a step increment of flows, both measured in connections-per-second. Once a flow entry is created for a flow, the T and S values may be used to determine which flows to examine, and a number of hashing functions to perform when determining whether a flow entry 232 corresponding to a flow is present in ST 230.

As explained in more detail below, rules engine 220 may use a skip count to determine whether to examine a flow and thus examine a packet belonging to that flow. A skip count indicates the number of flows to skip before examining a flow. Rules engine 220 determines the skip count N to generate a 1-in-N (1/N) flow examination function, where N indicates the number of flows to examine after skipping N−1 flows. For example, if N is set to a default rate equal to 1, rules engine 220 examines every flow that is being transmitted using a particular protocol, and thus every packet for that protocol is examined. If N is set to 3, rules engine 220 examines a packet belonging to 1 out of every 3 flows, after skipping 2 flows.

Rules engine 220 can adjust N from a user-configured default value to another value, based on user-configured values for S and T. If the current number of actual flows C is less than T, rules engine 220 examines every 1-in-N flows. For example, if N is set to a default value of 1, T is set to a default value of 200, and the current number of actual flows C is below 200, rules engine 220 examines each flow of a protocol. Once C exceeds T, as indicated, for example, by a new flow entry having been created, rules engine 220 increases N to reduce number of flows examined. In other words, unlike a conventional network intrusion detection system, NIDU 200 is able to throttle flow examination, which reduces the likelihood of a successful saturation attack on NIDU 200.

Rules engine 220 increases N based on the product of a user-defined skip-count modifier A, and a number X of steps S by which C exceeds T. For example, if T is set to 200, S is set to 50, A is set to 2, and C is 200, then X is 2, since C exceeds T by 100, i.e., 2 times S. Thus, rules engine 220 increases N to A times X, which equals 4, and thus 1 in 4 flows will be examined for a valid state transition. If, for example, C increases further, to 510, then X is 6, since C exceeds T by 310, which is nearest to 6 times S. Thus, rules engine 220 increases N to 12, and 1 in 12 flows will be examined for a valid state transition. In one embodiment, rules engine 220 uses the whole number component of X. In another embodiment, rules engine 220 rounds X up or down to nearest whole number.

As described in more detail below, rules engine 220 performs a hashing function based on values in a packet, to determine whether a flow entry 232 corresponding to a flow is present in ST 230. In order for there to be a flow entry 232 corresponding to a flow, the flow entry 232 has to match the result of the hashing function, and the hashed values from the packet have to match entry-generation values 2322 indicated in the flow entry 232.

Any number of values when hashed can generate the same result. Therefore, it is possible that rules engine 220 fails to locate a matching flow entry 232 because the hashed values from the packet fail to match entry-generation values 2322, though the flow entry 232 matches the result of the hashing function. If rules engine 220 fails to locate a matching flow entry 232 after performing a hashing function, rules engine 220 may perform any number of additional hashing functions R.

The flow examination function 11N can affect the number of additional hashing functions R performed. In general, as N increases, meaning that fewer flows are being examined, R increases, and thus the probability of locating a flow in ST 230 should increase. It follows that as N decreases, meaning that more flows are examined, R decreases, since the probability of locating a flow in ST 230 should increase as more flows are examined. This is because performing multiple hashing functions and monitoring fewer flows reduces the probability of locating a flow entry 232 that matches the result of the hashing function, but whose entry-generation values 2322 do not match the packet values hashed to generate the result. Similarly, performing fewer hashing functions and monitoring more flows also reduces this probability.

Rₘᵢₙ is a user-configured minimum number of additional hashing functions related to N, and Rₘₐₓ is a user-configured maximum number of additional hashing functions. When N is at its default value, the number of additional hashing functions performed is Rₘᵢₙ. As rules engine 220 increases N, the number of additional hashing functions performed increases to R, which is between Rₘᵢₙ and Rₘₐₓ. As rules engine 220 further increases N, R increases until it reaches Rₘₐₓ, and does not increase further. Similarly, as rules engine 220 decreases N to its default value, R decreases until it reaches Rₘᵢₙ.

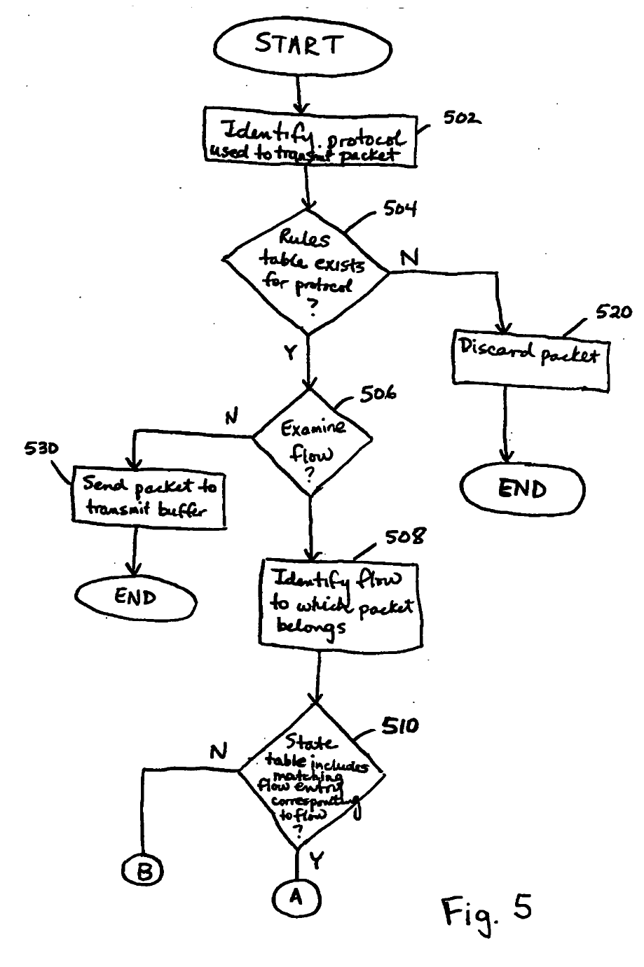

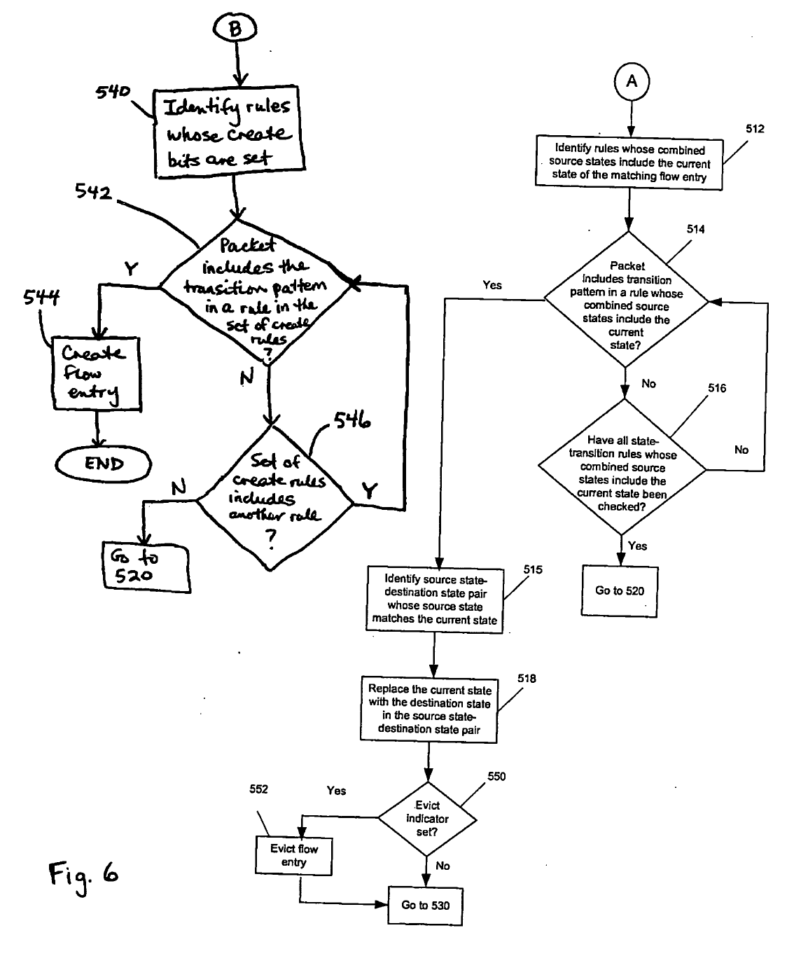

FIG. 5 and FIG. 6 are a flow chart illustrating an example embodiment of a method of network intrusion detection. At 502 of method 500, classifier 210 identifies a protocol used to transit a packet received in a receive buffer. The protocol may be identified based, for example, on a protocol identifier. A protocol identifier may be, for example, a protocol flag in the protocol field of the packet's header, or other data in the packet's header or payload.

Once the protocol is identified, at 504 rules engine 220 determines whether a RT 240 exists for the identified protocol. In one embodiment, rules engine 220 determines whether a RT 240 includes table identifier 242 that corresponds to the packet's protocol identifier. In one embodiment, if RT 240 does not exist for the protocol, at 520, rules engine 220 discards the packet. In another embodiment, if RT 240 does not exist for the protocol, the packet is transmitted. In yet another embodiment, if RT 240 does not exist for the protocol, rules engine 220 updates statistics regarding the number of packets belonging to an intrusive flow. If the packet has caused a user-configured number of intrusive packets to be reached, the packet is discarded, while the packet is transmitted if it has not caused the number of intrusive packets to be reached.

At 506, rules engine 220 determines whether the flow is to be examined to determine whether the flow will transition from a current state 2324 indicated in ST 230 to a destination state in valid destination states 2446 indicated in RT 240, and thus constitutes a valid packet that is not associated with a network intrusion. Although FIG. 5 and FIG. 6 are described in terms of rules engine 220 determining whether a flow is to be examined, embodiments of the invention may be practiced without rules engine 220 determining whether a flow is to be examined.

Rules engine 220 determines whether to examine the flow based on a skip count. If the skip count indicates that a flow is not to be examined, rules engine 220 increments the skip count to indicate that a flow has been skipped. If the flow is to be examined, rules engine 220 resets the skip count to restart counting the number of flows to skip before examining a flow.

If the flow is not examined, at 530, rules engine 220 sends the packet belonging to the flow to a transmit buffer, to be transmitted to destination 108, if NIDU 200 is running on network device 106, or to be processed at destination 108, if NIDU 200 is running on destination 108. For purposes of illustration and ease of explanation, the remainder of FIG. 5 and FIG. 6 will be described in terms of NIDU 200 running on destination 108.

If the flow is to be examined, at 508 classifier 210 identifies the flow to which the packet belongs. Classifier 210 can identify the flow in any manner known in the art. For example, the flow may be identified based on the protocol, where, for example, a flow transmitted using TCP is identified by certain information in the packet's header, while a flow transmitted using FTP is identified by different information in the packet's header.

Once the flow has been identified, at 510 rules engine 220 determines whether ST 230 includes a matching flow entry 232 corresponding to the flow. In one embodiment, rules engine 220 performs a hashing function based on values in the packet, determines whether a flow entry 232 matches the result of the hashing function, and determines whether the hashed values from the packet match entry-generation values 2322 indicated in the flow entry 232. For example, if the protocol is TCP, the source address, destination address, source port, and destination port values may be entry-generation values 2322, as well as values in a packet used to perform a hashing function. Rules engine 220 may perform any hashing function known in the art.

In one embodiment, rules engine 220 performs multiple hashing functions, that is, one or more hashes where the values used to perform the hashing function are in their original locations in the packet, and one or more hashes where the values are switched. For example, if the protocol is TCP, rules engine 220 could perform two hashing functions, the first hash being a regular four-tuple, as is known in the art, and the other hash performed with the source and destination fields switched and the source port and destination port fields switched. If hashing values are switched to perform a hashing function, rules engine 220 determines whether the order of entry-generation values 2322 correspond to the order of the values in the packet as hashed to generate the hash result. In another embodiment, rules engine 220 performs a single hashing function, for example a hashing function with values in a packet in their regular positions, or a hashing function with values switched.

In one embodiment, if matching flow entry 232 is not found initially, rules engine 220 performs a number of additional hashes according to R, as described above. In another embodiment, rules engine 220 does not perform additional hashes if a match is not found after the initial hashing function.

If a matching flow entry 232 is not found after one or more attempts, at 540, rules engine 220 identifies a set of one or more state-transition rules 244-N whose create bits 2448 are set. At 542, rules engine 220 determines whether the packet includes transition pattern 2444 included in one of the state-transition rules 244-N in the set of create rules. If the packet includes transition pattern 2444, at 544 rules engine 220 performs a hashing function based on data in the packet to create a flow entry 232 corresponding to the packet's flow. The hashing function may be any hashing function known in the art.

However, if the packet does not include transition pattern 2444, at 546 rules engine 220 determines whether the set of create rules includes another state-transition rule 244. If the set includes another state-transition rule 244, rules engine 220 returns to 542. Conversely, if the set does not include another state-transition rule 244-N (or if no state-transition rule indicates creating a flow entry), the packet is deemed to be associated with a network intrusion, because the packet's flow is neither included in ST 230 nor targeted for inclusion in ST 230. In one embodiment, rules engine 220 discards the packet at 520. In another embodiment, rules engine 220 discards the packet if it causes a number of intrusive packets to be reached, but otherwise transmits the packet, as described previously.

However, if at 510 ST 230 includes a matching flow entry 232 corresponding to the flow, at 512 rules engine 220 identifies a set of state-transition rules 244-N whose combined source states 2442 include current state 2324 of matching flow entry 232. In one embodiment, rules engine 220 performs an AND operation using combined source states 2442 and current state 2324. Rules engine 220 compares the result of the AND operation to current state 2324, to identify state-transition rules 244-N whose combined source states include current state 2324. A state-transition rule 244-N includes current state 2324 if current state 2324 matches the result of the AND operation performed using the state transition rule's combined source states. Although an AND operation is described, other operations such as, but not limited to, tree search operations, may be used.

Once the state-transition rules 244-N whose combined source states 2442 include current state 2324 of matching flow entry 232, at 514 rules engine 220 determines whether the packet includes transition pattern 2444 included in one of the state-transition rules. If the packet does not include transition pattern 2444, at 516 rules engine 220 determines whether all state-transition rules that include the matching flow entry 232 have been checked. If not, rules engine 220 returns to 514. Conversely, all state-transition rules that include the matching flow entry 232 have not been checked, rules engine 220 discards the packet at 520. In another embodiment, rules engine 220 discards the packet if it causes a number of intrusive packets to be reached, but otherwise transmits the packet, as described previously.

If at 514 the packet includes transition pattern 2444, at 515 rules engine 220 identifies a SS-DD Pair whose source state matches current state 2324. At 518, rules engine 220 replaces current state 2324 with the destination state of the SS-DD Pair whose source state matches current state 2324. At 550, rules engine 220 determines whether evict bit 2450 of the SS-DD Pair is set. If evict bit 2450 is not set, rules engine 220 sends the packet to the transmit buffer at 530. If the evict bit is set, at 552 rules engine 220 evicts matching flow entry 232 from ST 230 and sends the packet to the transmit buffer at 530.

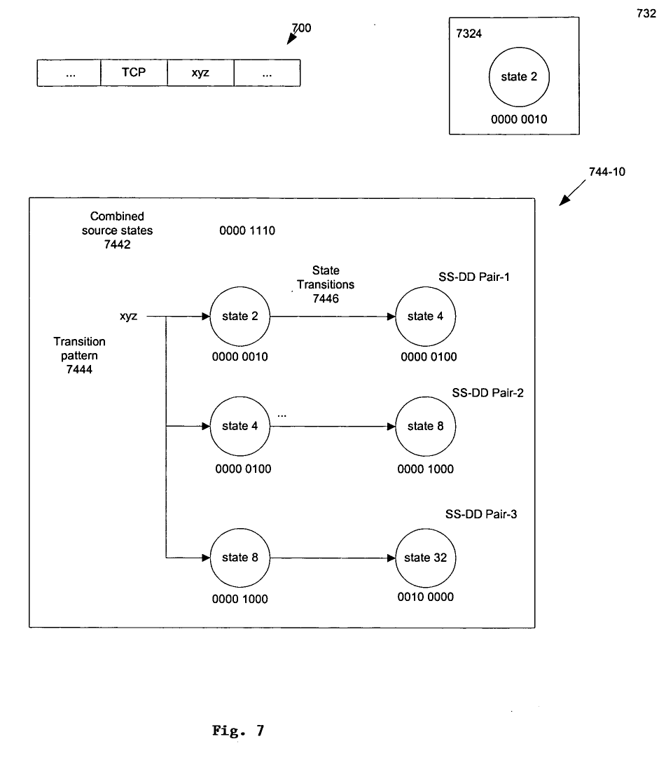

FIG. 7 illustrates an example embodiment of determining a valid state transition. A packet that includes a pattern XYZ arrives in the receive buffer of NIDU 200. A protocol identifier in packet 700 indicates packet 700's protocol as TCP. Rules engine 220 determines that the protocol is TCP and determines based on a table identifier 242, which matches packet 700's protocol identifier, that a RT 240 exists for TCP.

Rules engine 220 identifies the flow to which packet 700 belongs, and identifies a flow entry 732 that corresponds to the flow of packet 700. The current state 7324 is state 2, as indicated by the bit-vector 00000010. Rules engine 220 performs an AND operation using current state 7324 and combined source states 2442 of state-transition rules 244-N. One of the state-transition rules whose combined source states 7442 include current state 7324 is state-transition rule 744-10. Specifically, the result of the AND operation using combined source states 7442 (00001110) and current state 7324 (00000010) is 00000010, which matches current state 7324. Packet 700 includes transition pattern 7444, i.e., XYZ, in state transition rule 744-10. Consequently, a destination state of SS-DD Pair-1 in transition states 7446, i.e., state 4, which corresponds to source state 2 in SS-DD Pair-1, indicates the next state of the flow represented by flow entry 732. Therefore, packet 700 is a valid packet, and rules engine 220 replaces state 2 in current state 7324 with state 4 from SS-DD Pair-1.

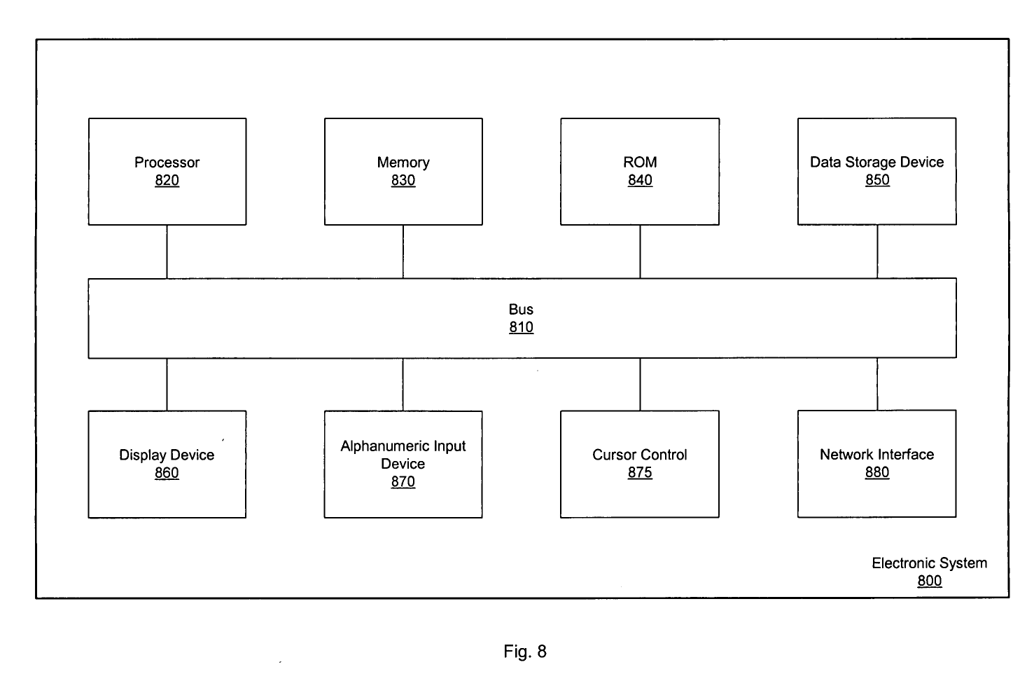

FIG. 8 is a block diagram of one embodiment of an electronic system. In one embodiment, the technique described herein can be implemented as sequences of instructions executed by an electronic system. The electronic system is intended to represent a range of electronic systems, including, for example, a personal computer, a personal digital assistant (PDA), a laptop or palmtop computer, a cellular phone, a computer system, a network access device, etc. Other electronic systems can include more, fewer and/or different components. The electronic system can be coupled to a wired network, e.g., via a coaxial cable, fiber-optic cable or twisted-pair wire, a wireless network, e.g., via radio or satellite signals, or a combination thereof. The sequences of instructions can be stored by the electronic system. In addition, the instructions can be received by the electronic system (e.g., via a network connection).

Electronic system 800 includes a bus 810 or other communication device to communicate information, and processor 820 coupled to bus 810 to process information. While electronic system 800 is illustrated with a single processor, electronic system 800 can include multiple processors and/or co-processors.

Electronic system 800 further includes random access memory (RAM) or other dynamic storage device 830 (referred to as memory), coupled to bus 810 to store information and instructions to be executed by processor 820. Memory 830 also can be used to store temporary variables or other intermediate information while processor 820 is executing instructions. Electronic system 800 also includes read-only memory (ROM) and/or other static storage device 840 coupled to bus 810 to store static information and instructions for processor 820. In addition, data storage device 850 is coupled to bus 810 to store information and instructions. Data storage device 850 may comprise a magnetic disk (e.g., a hard disk) or optical disc (e.g., a CD-ROM) and corresponding drive.

Electronic system 800 may further comprise a display device 860, such as a cathode ray tube (CRT) or liquid crystal display (LCD), to display information to a user. Alphanumeric input device 870, including alphanumeric and other keys, is typically coupled to bus 810 to communicate information and command selections to processor 820. Another type of user input device is cursor control 875, such as a mouse, a trackball, or cursor direction keys to communicate direction information and command selections to processor 820 and to control cursor movement on flat-panel display device 860. Electronic system 800 further includes network interface 880 to provide access to a network, such as a local area network or wide area network.

Instructions are provided to memory from a machine-accessible medium, or an external storage device accessible via a remote connection (e.g., over a network via network interface 880) providing access to one or more electronically-accessible media, etc. A machine-accessible medium includes any mechanism that provides (i.e., stores and/or transmits) information in a form readable by a machine (e.g., a computer). For example, a machine-accessible medium includes random-access memory (RAM), such as static RAM (SRAM) or dynamic RAM (DRAM); ROM; magnetic or optical storage medium; flash memory devices; electrical, optical, acoustical or other form of propagated signals (e.g., carrier waves, infrared signals, digital signals); etc.

In alternative embodiments, hard-wired circuitry can be used in place of or in combination with software instructions to implement the embodiments of the invention. Thus, the embodiments of the invention are not limited to any specific combination of hardware circuitry and software instructions.

Reference in the foregoing specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the foregoing specification, the invention has been described with reference to specific embodiments thereof. It will, however, be evident that various modifications and changes can be made thereto without departing from the broader spirit and scope of the embodiments of the invention. The specification and drawings are, accordingly, are to be regarded in an illustrative rather than a restrictive sense.

1. A method for filtering packets, wherein a flow corresponds to a stream of packets for a particular communication session, comprising:
identifying a protocol used to transmit a packet;
identifying the flow to which the packet belongs;
determining whether a rules table exists for the protocol;
determining, if the rules table exists, whether a state table includes a matching flow entry corresponding to the flow;
determining, if the state table includes the matching flow entry, whether a state of the flow will transition from a current state indicated in the matching flow entry to a valid destination state indicated in a state-transition rule in the rules table; and
discarding the packet, if the state of the flow will not transition to the valid destination state.

2. The method of claim 1, wherein the protocol comprises a protocol whose operation is capable of being defined by a finite state machine.

3. The method of claim 2, wherein the protocol comprises one of the following: File Transfer Protocol, Telnet, Hypertext Transfer Protocol, H.323, Real Time Transport Protocol/Real Time Control Protocol and Secure Shell Protocol.

4. The method of claim 1, further comprising discarding the packet, if no rules table exists for the protocol.

5. The method of claim 1, further comprising transmitting the packet if no rules table exists for the protocol.

6. The method of claim 1, further comprising transmitting the packet if the flow will transition to the valid destination state.

7. The method of claim 1, further comprising:
determining whether the flow causes a skip count to be reached, wherein the skip count indicates a flow to examine after skipping a number of flows;
examining the flow, if the flow causes the skip count to be reached;
resetting the skip count, if the flow is examined;
skipping the flow, if the flow fails to cause the skip count to be reached; and
incrementing the skip count, if the flow is skipped.

8. The method of claim 7, further comprising:
determining that a number of actual flows fails to exceed a preset threshold of flows; and
examining flows based on the skip count, as a result of the number of actual flows failing to exceed the preset threshold.

9. The method of claim 7, further comprising:
determining that a number of actual flows exceeds a preset threshold of flows;
determining a number of preset steps by which the number of actual flows exceeds the preset threshold;
multiplying the number of preset steps by a preset skip-count modifier; and
changing the skip count to a different skip count equal to the product of the preset number of steps and the preset skip-count modifier.

10. The method of claim 1, wherein determining whether the state table includes the matching flow entry comprises:
performing a hashing function based, at least in part, on values in the packet;
determining whether a flow entry matches a result of the hashing function;
determining, if the flow entry matches the result, whether the packet values hashed to generate the result match values used to generate the flow entry; and
determining, if the packet values match the values used to generate the flow entry, that the flow entry is the matching flow entry.

11. The method of claim 10, further comprising:
performing one or more additional hashing functions according to a number related to a skip count, if no flow entry matches the result of the hashing function, wherein the skip count indicates a flow to examine after skipping a number of flows; and
performing the one or more additional hashing functions according to the number related to the skip count, if the flow entry matches the result of the hashing function, but the packet values fail to match the values used to generate the flow entry.

12. The method of claim 11, wherein performing the one or more additional hashing functions according to the number related to the skip count comprises:
performing a preset minimum number of additional hashing functions, if the skip count comprises a first value;
performing an increased number of additional hashing functions, if the skip count is increased, wherein the increased number of additional hashing functions is greater than the preset minimum number of additional hashing functions, but less than a preset maximum number of additional hashing functions; and
performing the preset maximum number of additional hashing functions, when the increased number of additional hashing functions reaches the preset maximum number of additional hashing functions.

13. The method of claim 10, further comprising:
identifying, if the state table fails to include the matching flow entry, a set of one or more state-transition rules having an indication to create an additional flow entry;
determining whether the packet includes a transition pattern indicated in a state-transition rule in the set, wherein the transition pattern indicates that the additional flow entry is to be created;
creating the additional flow entry, if the packet includes the transition pattern; and
discarding the packet, if the packet fails to include the transition pattern.

14. The method of claim 1, wherein determining whether the state of the flow will transition to the valid destination state comprises:
performing an operation using the current state and combined source states indicated in a state-transition rule;
determining whether the current state matches a result of the operation;
determining, if the current state matches the result of the operation, that the combined source states include the current state;
determining, as a result of the combined source states including the current state, whether the packet includes a transition pattern indicated in the state-transition rule; and
determining, if the packet includes the transition pattern, that the state of the flow 11 will transition from the current state to the valid destination state in the state-transition rule in the set.

15. The method of claim 14, wherein the operation comprises an AND operation.

16. The method of claim 14, further comprising:
identifying in the state-transition rule, if the state of the flow will transition to the valid destination state, a source state-destination state pair that includes the current state; and
replacing the current state with the destination state indicated in the source state-destination state pair.

17. The method of claim 16, further comprising:
determining whether the source state-destination state pair includes an evict indication; and
evicting the matching flow entry, if the source state-destination state pair includes the evict indication.

18. The method of claim 14, further comprising
discarding the packet, if the packet fails to include the transition pattern included in a plurality of state-transition rules whose combined source states include the current state.

19. The method of claim 1, wherein discarding the packet comprises:
determining whether the packet causes a predetermined number of packets associated with invalid transitions to be reached; and
discarding the packet, if the packet causes the predetermined number to be reached.

20. An apparatus comprising:
a classifier, to identify a protocol used to transmit a packet and identify a stream of packets to which the packet belongs, wherein the stream of packets comprises a flow;
one or more rules tables that include one or more state-transition rules;
one or more state tables for the protocol that include one or more flow entries and values used to generate the flow entries; and
a rules engine, to determine whether a rules table exists for the protocol, determine, if the rules table exists, whether the state table includes a matching flow entry corresponding to the flow, determine, if the state table includes the matching flow entry, whether the flow will transition from a current state to a valid destination state indicated in a state-transition rule, and discard the packet, if the flow will not transition to the valid destination state.

21. The apparatus of claim 20, wherein the rules engine determines whether the state table includes the matching flow entry by performing a hashing function based, at least in part, on values in the packet, determining whether a flow entry matches a result of the hashing function, determining, if the flow entry matches the result, whether the packet values hashed to generate the result match values used to generate the flow entry, and determining, if the packet values match the values used to generate the flow entry, that the flow entry is the matching flow entry.

22. The apparatus of claim 20, wherein the rules engine determines whether the state of the flow will transition to the valid destination state by performing an operation using the current state and combined source states indicated in a state-transition rule, determining whether the current state matches a result of the operation, determining, if the current state matches the result of the operation, that the combined source states include the current state, determining, as a result of the combined source states including the current state, whether the packet includes a transition pattern indicated in the state-transition rule, and determining, if the packet includes the transition pattern, that the state of the flow will transition from the current state to the valid destination state in the state-transition rule in the set.

23. An article of manufacture comprising:
a machine-accessible medium including thereon sequences of instructions that, when executed, cause an electronic system to:
identify a protocol used to transmit a packet;
identify the flow to which the packet belongs;
determine whether a rules table exists for the protocol;
determine, if the rules table exists, whether a state table includes a matching flow entry corresponding to the flow;
determine, if the state table includes the matching flow entry, whether a state of the flow will transition from a current state indicated in the matching flow entry to a valid destination state indicated in a state-transition rule in the rules table; and
discard the packet, if the state of the flow will not transition to the valid destination state.

24. The article of manufacture of claim 23, wherein the machine-accessible medium further comprises sequences of instructions that, when executed, cause the electronic system to:
determine whether the flow causes a skip count to be reached, wherein the skip count indicates a flow to examine after skipping a number of flows;
examine the flow, if the flow causes the skip count to be reached;
reset the skip count, if the flow is examined;
skip the flow, if the flow fails to cause the skip count to be reached; and
increment the skip count, if the flow is skipped.

25. The article of manufacture of claim 24, wherein the machine-accessible medium further comprises sequences of instructions that, when executed, cause the electronic system to:
determine that a number of actual flows fails to exceed a preset threshold of flows; and
examine flows based on the skip count, as a result of the number of actual flows failing to exceed the preset threshold.

26. The article of manufacture of claim 24, wherein the machine-accessible medium further comprises sequences of instructions that, when executed, cause the electronic system to:
determining that a number of actual flows exceeds a preset threshold of flows;
determine a number of preset steps by which the number of actual flows exceeds the preset threshold;
multiply the number of preset steps by a preset skip-count modifier; and
change the skip count to a different skip count equal to the product of the preset number of steps and the preset skip-count modifier.

27. The article of manufacture of claim 23, wherein the sequences of instructions that, when executed, cause the electronic system to determine whether the state table includes the matching flow entry comprise sequences of instructions that, when executed, cause the electronic system to:
perform a hashing function based, at least in part, on values in the packet;
determine whether a flow entry matches a result of the hashing function;
determine, if the flow entry matches the result, whether the packet values hashed to generate the result match values used to generate the flow entry; and
determine, if the packet values match the values used to generate the flow entry, that the flow entry is the matching flow entry.

28. The article of manufacture of claim 27, wherein the machine-accessible medium further comprises sequences of instructions that, when executed, cause the electronic system to:
identify, if the state table fails to include the matching flow entry, a set of one or more state-transition rules having an indication to create an additional flow entry;
determine whether the packet includes a transition pattern indicated in a state-transition rule in the set, wherein the transition pattern indicates that the additional flow entry is to be created;
create the additional flow entry, if the packet includes the transition pattern; and
discard the packet, if the packet fails to include the transition pattern.

29. The article of manufacture of claim 23, wherein the sequences of instructions that, when executed, cause the electronic system to determine whether the state of the flow will transition to the valid destination state comprise sequences of instructions that, when executed, cause the electronic system to:
perform an AND operation using the current state and combined source states indicated in a state-transition rule;
determine whether the current state matches a result of the operation;
determine, if the current state matches the result of the operation, that the combined source states include the current state;
determine, as a result of the combined source states including the current state, whether the packet includes a transition pattern indicated in the state-transition rule; and
determine, if the packet includes the transition pattern, that the state of the flow will transition from the current state to the valid destination state in the state-transition rule in the set.

30. A system comprising:
a processor;
a network interface coupled with the processor; and
an article of manufacture comprising a machine-accessible medium including thereon sequences of instructions that, when executed, cause an electronic system to:
identify a protocol used to transmit a packet;
identify the flow to which the packet belongs;
determine whether a rules table exists for the protocol;
determine, if the rules table exists, whether a state table includes a matching flow entry corresponding to the flow;
determine, if the state table includes the matching flow entry, whether a state of the flow will transition from a current state indicated in the matching flow entry to a valid destination state indicated in a state-transition rule in the rules table; and
discard the packet, if the state of the flow will not transition to the valid destination state.

31. The system of claim 30, wherein the sequences of instructions that, when executed, cause the electronic system to determine whether the state table includes the matching flow entry comprise sequences of instructions that, when executed, cause the electronic system to:
perform a hashing function based, at least in part, on values in the packet;
determine whether a flow entry matches a result of the hashing function;
determine, if the flow entry matches the result, whether the packet values hashed to generate the result match values used to generate the flow entry; and
determine, if the packet values match the values used to generate the flow entry, that the flow entry is the matching flow entry.

32. The system of claim 30, wherein the machine-accessible medium further comprises sequences of instructions that, when executed, cause the electronic system to:
identify, if the state table fails to include the matching flow entry, a set of one or more state-transition rules having an indication to create an additional flow entry;
determine whether the packet includes a transition pattern indicated in a state-transition rule in the set, wherein the transition pattern indicates that the additional flow entry is to be created;
create the additional flow entry, if the packet includes the transition pattern; and
discard the packet, if the packet fails to include the transition pattern.

33. The system of claim 30, wherein the sequences of instructions that, when executed, cause the electronic system to determine whether the state of the flow will transition to the valid destination state comprise sequences of instructions that, when executed, cause the electronic system to:
perform an AND operation using the current state and combined source states indicated in a state-transition rule;
determine whether the current state matches a result of the operation;
determine, if the current state matches the result of the operation, that the combined source states include the current state;
determine, as a result of the combined source states including the current state, whether the packet includes a transition pattern indicated in the state-transition rule; and
determine, if the packet includes the transition pattern, that the state of the flow will transition from the current state to the valid destination state in the state-transition rule in the set.
